(19) United States
(12) Patent Application Publication
(10) Pub. No.: US 2009/0082607 A1
(43) Pub. Date: Mar. 26, 2009

(54) METHOD FOR TREATING FLUORIDE-CONTAINING WASTE WATER AND SYSTEM OF TREATING WASTE WATER

(75) Inventors: Chen-Chung Huang, Hsinchu (TW); Kun-Sen Sung, Miaoli (TW); Chih-Hung Lin, Tainan County (TW); Yi-Lin Yang, Pingtung County (TW)

Correspondence Address: J C PATENTS, INC., 4 VENTURE, SUITE 250, IRVINE, CA, 92618, US

(73) Assignee: POWERCHIP SEMICONDUCTOR CORP., Hsinchu (TW)

(21) Appl. No.: 11/861,794

(22) Filed: Sep. 26, 2007

(51) Int. Cl. A62D 3/30; B01D 9/02; B01J 19/00

(52) U.S. Cl. 588/313; 422/224; 422/245.1

(57) ABSTRACT

A method for treating fluoride-containing waste water is disclosed. The method includes, first, inducing fluoride-containing waste water and calcium compound into a crystallization reaction tank having a plurality of crystallizing webs so as to conduct a reaction between the fluoride-containing waste water and the calcium compound to form calcium fluoride crystals on the crystallizing webs; meanwhile, stirring the fluoride-containing waste water and the; then, discharging the fluoride-containing waste water out of the crystallization reaction tank for conducting a successive treating step.

### BACKGROUND OF THE INVENTION

1. Field of the Invention

The present invention generally relates to a method for treating waste water and a system of treating waste water, and more particularly, to a method for treating fluoride-containing waste water and a system of treating waste water.

2. Description of Related Art

In the industry practices, for example, fabricating glass, plating process, refining aluminum and steel, and process of semiconductor device, fluoride is popularly and largely used, from which an issue of treating fluoride-containing waste water is derived. In order to avoid fluorine ions (F⁻) to contaminate our environment and to make the industrious water effluent meet the relevant emission standard for hazardous waste worked out by government, many efforts have been made intending to minimize the negative impact of industrious water effluent on the environment.

In general speaking, a technique for treating fluoride-containing waste water includes chemical coagulation method and fluidized bed crystallization (FBC) method. The chemical coagulation method is based on the fluorine ions (F⁻) concentration in fluoride-containing waste water where calcium compound solution with an appropriate concentration is added into to form insoluble calcium fluoride (CaF₂) compound, following by adding coagulant and coagulant aid to coagulate, flocculate and precipitate the compound. Thereafter, the CaF₂ compound can be separated. By using the FBC method, waste water and calcium compound are purred into a specifically-designed fluidized bed reaction tank, where under a strict and accurate program control the calcium fluoride would be crystallized on supports, the crystals would be gradually grown and finally be separated from the fluoride-containing waste water.

Since the component complexity of fluoride-containing waste water which contains also other kinds of chemicals except for waste fluoride acid, such as waste sulfuric acid and waste phosphonic acid, thus, the above-mentioned treating procedure is not perfected and some bottlenecks hard to be solved are remained. For example, the FBC method is quite sensitive to the interferences of sulfate (SO₄²⁻) and phosphate (PO₄³⁻). That is to say, the waste sulfuric acid and the waste phosphonic acid in the fluoride-containing waste water would suppress the removing efficiency of fluorine ion (F⁻) which makes the waste water after the treating fail to meet an expected standard.

In terms of chemical coagulation method, the encountered problem is, for example, the dirt of calcium fluoride (CaF₂) is easily built up on the inner walls of a waste water reaction tank and the pipelines thereof. Thus, the waste water reaction tank must be aperiodically cleaned up while shutting down the machines, which affects the treating speed of fluoride-containing waste water. If the dirt-depositing problem is serious, the efficiency of treating the fluoride-containing waste water in a tank body would be deteriorated and the lifetime in years of the treating equipment would be shortened.

In addition, if the fluoride acid (HF) concentration is unknown, calcium compound in excess of quantities may be added to enhance the chance of producing fluorine ions (F⁻) and calcium salt. As a consequence, the residual amount of calcium in waste water must be high-deflected in the successive treating process of waste water.

Moreover, in order to enhance the collision chance between molecules, the usage amount of the coagulant and the coagulant aid must be increased in the successive coagulation and flocculation process. Accordingly, the yield of fluorine-family hazardous sludge would be largely increased, which makes the cost for cleaning up, transporting and processing the hazardous waste.

### SUMMARY OF THE INVENTION

Accordingly, the present invention is directed to provide a method for treating fluoride-containing waste water, which can effectively lighten the dirt-depositing problem on the walls of a reaction tank, largely reduce the usage amounts of calcium compound, coagulant and coagulant aid, the yield of sludge, lower the cost of treating waste water and make the treated fluoride-containing waste water meet the relevant emission standard for hazardous waste regardless of whether the water quality of the incoming fluoride-containing waste water.

The present invention is directed also to provide a crystallizing tank of waste water, capable of effectively treating the waste water with unstable water quality, lowering the chemical dosages of coagulant and coagulant aid, producing less sludge, lowering the cost for treating waste water, lengthening the lifetime of an equipment of treating waste water and making the discharged waste water from the crystallizing tank of waste water pass the relevant emission standard for hazardous waste.

The present invention is directed further to provide a system of treating waste water, which requires less coagulant and coagulant aid to effectively precipitate the contaminant in waste water, produces less sludge and effectively lowers operation cost of treating waste water and sludge.

The present invention provides a method for treating fluoride-containing waste water. First, fluoride-containing waste water and calcium compound are poured into a crystallization reaction tank having multiple crystallizing webs for a reaction between the fluoride-containing waste water and calcium compound so as to form calcium fluoride (CaF₂) crystals on the crystallizing webs. The fluoride-containing waste water and the calcium compound are stirred. Then, the fluoride-containing waste water is drained out of the crystallization reaction tank to conduct the successive process steps.

In an embodiment of the present invention, the material of the above-mentioned crystallizing web is, for example, stainless steel 316 or nickel chromium molybdenum steel.

In an embodiment of the present invention, the above-mentioned crystallizing webs in the crystallization reaction tank are, for example, arranged in parallel to each other.

In an embodiment of the present invention, the surfaces of the above-mentioned crystallizing webs are, for example, arranged in perpendicular to or parallel to the bottom of the crystallization reaction tank.

In an embodiment of the present invention, the above-mentioned calcium compound is, for example, calcium hydroxide (Ca(OH)₂) or calcium chloride (CaCl₂).

In an embodiment of the present invention, the above-mentioned process steps include following steps, for example. First, the fluoride-containing waste water and the calcium compound are poured into a reaction tank to create calcium fluoride (CaF₂) by a reaction between the fluoride-containing waste water and the calcium compound. Next, the fluoride-containing waste water and coagulant are poured into a coagulating tank to coagulate the calcium fluoride (CaF₂). Then, the fluoride-containing waste water and coagulant aid are poured into a flocculating tank, and the fluoride-containing waste water is stirred for forming calcium fluoride flocs in the waste water. Further, the fluoride-containing waste water is poured into a sludge-precipitating tank.

In an embodiment of the present invention, the above-mentioned coagulant is, for example, aluminum salt or iron salt.

In an embodiment of the present invention, the above-mentioned coagulant aid is, for example, macromolecule polymer.

In an embodiment of the present invention, the above-mentioned method further includes a step of removing the calcium fluoride (CaF₂) crystals on the crystallizing webs by shaking the crystallizing webs to drop the calcium fluoride (CaF₂) crystals off from the crystallizing webs.

By using the method for treating fluoride-containing waste water of the present invention, the calcium fluoride (CaF₂) crystals formed after a reaction between the fluorine ions and calcium compound dwell on the crystallizing webs in the crystallization reaction tank, which is able to effectively reduce the dirt-depositing on the inner walls of a waste water reaction tank and the pipelines thereof.

In addition, since most of the fluorine ions (F⁻) have been reacted with the calcium compound on the crystallizing webs to form the calcium fluoride (CaF₂) crystals, thus, the chemical dosages of coagulant and coagulant aid can be reduced in the successive treating steps and the yield of sludge is lowered, which contribute to effectively lower the cost of treating fluoride-containing waste water.

The present invention also provides a crystallizing tank of waste water suitable for a system of treating waste water. The crystallizing tank includes a tank body, a crystallizing device, an agitator, an inlet pipeline of waste water, an outlet pipeline of waste water, and an agent-feeding line. The crystallizing device is disposed in the tank body and includes a shaking part, a supporting part and multiple crystallizing webs. The supporting part connects the shaking part. The crystallizing webs are disposed on the supporting part. The agitator is disposed in the tank body. The inlet pipeline of waste water is connected between the tank body and a tank of raw waste water. The outlet pipeline of waste water is connected between the tank body and a reaction tank of waste water of the system of treating waste water. The agent-feeding line is disposed on the tank body.

In an embodiment of the present invention, the material of the above-mentioned crystallizing web is, for example, stainless steel 316 or nickel chromium molybdenum steel.

In an embodiment of the present invention, the above-mentioned crystallizing webs in the tank body are, for example, arranged in parallel to each other.

In an embodiment of the present invention, the surfaces of the above-mentioned crystallizing webs are, for example, arranged in perpendicular to or parallel to the bottom of the tank body.

In an embodiment of the present invention, the above-mentioned agitator is, for example, propeller type agitator, paddle type agitator or turbine type agitator.

The present invention makes the portion to be removed (for example, fluorine ions) in waste water react with a specific chemical (for example, calcium compound) to create crystals (for example, calcium fluoride (CaF₂) crystals) on the crystallizing webs, thus, the dirt-depositing on the inner walls of the reaction tank and in the pipelines thereof can be improved. Besides, the crystallizing tank of waste water of the present invention has removed most of hazardous substance in the waste water, thus, the dosages of the chemicals in the successive process, such as coagulant and coagulant aid, can be saved, and the sludge yield is reduced, which effectively save the cost of treating waste water.

The present invention further provides a system of treating waste water, which includes a tank of raw waste water, a crystallizing tank of waste water; a reaction tank of waste water, a coagulating tank, a flocculating tank and a sludge-precipitating tank. The crystallizing tank of waste water connects the tank of raw waste water and includes a tank body, a shaking part, a supporting part, multiple crystallizing webs, an agitator and an agent-feeding line. The crystallizing webs are disposed on the supporting part. The agitator is disposed in the tank body. The reaction tank of waste water connects the crystallizing tank of waste water. The coagulating tank connects the reaction tank of waste water. The flocculating tank connects the coagulating tank. The sludge-precipitating tank connects the flocculating tank.

In an embodiment of the present invention, the material of the above-mentioned crystallizing web is, for example, stainless steel 316 or nickel chromium molybdenum steel.

In an embodiment of the present invention, the above-mentioned crystallizing webs in the tank body are, for example, arranged in parallel to each other.

In an embodiment of the present invention, the surfaces of the above-mentioned crystallizing webs are, for example, arranged in perpendicular to or parallel to the bottom of the tank body.

In an embodiment of the present invention, the above-mentioned coagulating tank further includes a first pipeline for pouring coagulant into the coagulating tank.

In an embodiment of the present invention, the above-mentioned coagulant is, for example, aluminum salt or iron salt.

In an embodiment of the present invention, the above-mentioned flocculating tank further includes a second pipeline for pouring coagulant aid into the flocculating tank.

In an embodiment of the present invention, the above-mentioned coagulant aid is, for example, macromolecule polymer.

The system of treating waste water of the present invention uses the crystallizing tank of waste water to remove most of the hazardous substance in the waste water and make the hazardous substance crystallized in solid form, then conducts successive chemical coagulating, flocculating and precipitating processes. Since after the treating by the crystallizing tank of waste water, the concentration of suspended solid particles is largely diluted, thus, the usage amounts of the coagulant and the coagulant aid are saved and the sludge yield is significantly reduced. On the whole, the present invention is advantageous in significantly lowering the operation cost for treating waste water and agent-saving, time-saving and advancing chemical reaction efficiency.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a structure diagram of a system of treating waste water according to an embodiment of the present invention.

FIG. 2 is a structure diagram of a crystallizing tank of fluoride-containing waste water according to an embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

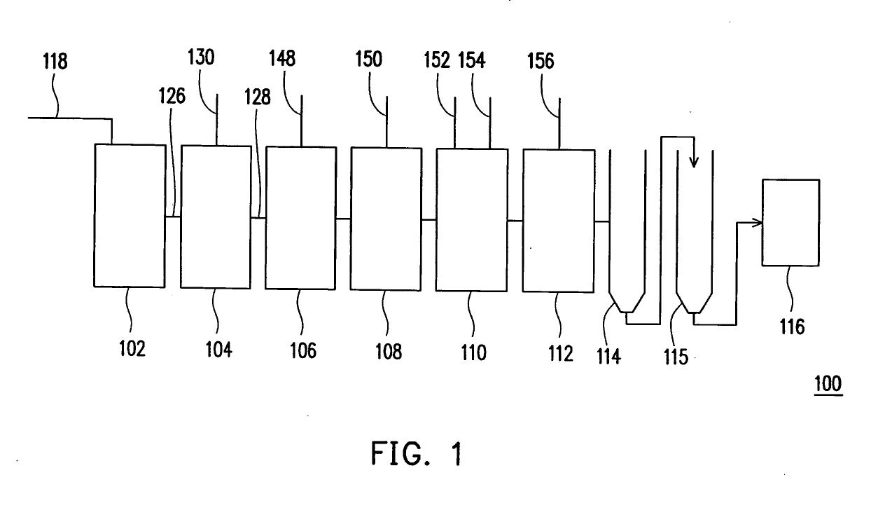

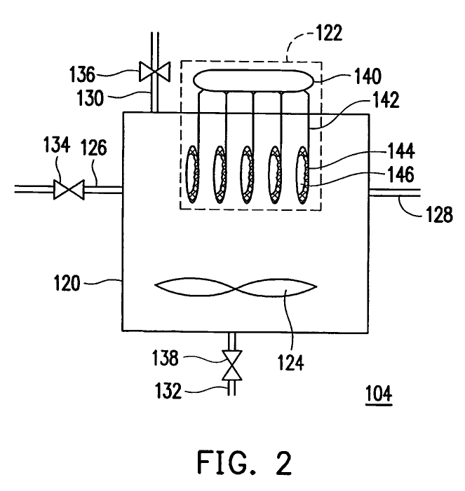

FIG. 1 is a structure diagram of a system of treating waste water according to an embodiment of the present invention, and FIG. 2 is a structure diagram of a crystallizing tank of fluoride-containing waste water according to an embodiment of the present invention. The present embodiment takes fluoride-containing waste water as an example to depict the structure of a system of treating waste water. Referring to FIG. 1, a system of treating waste water 100 includes, for example, a tank of raw fluoride-containing waste water 102, a crystallizing tank of fluoride-containing waste water 104, two reaction tanks of fluoride-containing waste water 106 and 108, a coagulating tank 110, a flocculating tank 112, a sludge-precipitating tank 114, a sludge-concentrating tank 115 and a machine for making sludge cake 116, wherein the number of the disposed reaction tanks of fluoride-containing waste water is not limited to two only, instead, the real number thereof depends on the production need. The tank of raw fluoride-containing waste water 102 is for storing used fluoride-containing waste water of various processes and the fluoride-containing waste water includes, for example, engineering waste water of fluoride acid-family, recycling waste water of reclaiming equipment, waste water of cutting machine or reverse osmosis washing water. In an embodiment, the tank of raw fluoride-containing waste water 102 has, for example, a first pipeline 118, and the fluoride-containing waste water is poured into the tank of raw fluoride-containing waste water 102 through the first pipeline 118.

Referring to FIGS. 1 and 2, the crystallizing tank of fluoride-containing waste water 104 includes a tank body 120, a crystallizing device 122, an agitator 124, an inlet pipeline of fluoride-containing waste water 126, an outlet pipeline of fluoride-containing waste water 128, an agent-feeding line 130 and a crystals-outputting pipeline 132. The tank body 120 is made of, for example, stainless steel 316. The agitator 124 is disposed in the tank body 120 for evenly stirring the fluid in the tank body 120 to enhance the collision chance between the calcium compound and the fluorine ions in the fluoride-containing waste water. The agitator 124 is, for example, propeller type agitator, paddle type agitator or turbine type agitator. The inlet pipeline of fluoride-containing waste water 126 is connected between the tank body 120 and the tank of raw fluoride-containing waste water 102 for inducing the fluoride-containing waste water from the tank of raw fluoride-containing waste water 102 to the crystallizing tank of fluoride-containing waste water 104. The inlet pipeline of fluoride-containing waste water 126 has a first control valve 134 for controlling the flowing status of the fluoride-containing waste water in the inlet pipeline of fluoride-containing waste water 126. The outlet pipeline of fluoride-containing waste water 128 is connected between the tank body 120 and the reaction tank of fluoride-containing waste water 106 for inducing the treated fluoride-containing waste water into the reaction tank of fluoride-containing waste water 106. The agent-feeding line 130 is disposed on the tank body 120 and has a second control valve 136 for adding the calcium compound into the fluoride-containing waste water in the tank body 120, wherein the calcium compound able to react with the fluoride-containing waste water into calcium fluoride (CaF₂) crystals is, for example, calcium hydroxide (Ca(OH)₂) or calcium chloride (CaCl₂). The crystals-outputting pipeline 132 is disposed on the bottom of the tank body 120, an a third control valve 138 is disposed on the crystals-outputting pipeline 132.

Continuing to FIG. 2, the crystallizing device 122 is disposed in the tank body 120 and includes a shaking part 140, a supporting part 142 and multiple crystallizing webs 144. The supporting part 142 connects the shaking part 140, the crystallizing webs 144 are disposed on the supporting part 142, the supporting part 142 is for fixing the crystallizing webs 144 and the supporting part 142 can be made of any acid-proof and corrosion-resisting material.

The material of the above-mentioned crystallizing web 144 is, for example, stainless steel 316 or nickel chromium molybdenum steel. The number of the disposed crystallizing webs 144 depends on a real need. The crystallizing webs 144 are arranged in parallel to each other in the tank body 120, while the surfaces of the crystallizing webs 144 are arranged, for example, either in perpendicular to the bottom of the tank body 120 or parallel to the bottom thereof.

The fluoride-containing waste water in the tank body 120 induced through the inlet pipeline of fluoride-containing waste water 126 contacts the calcium compound induced through the agent-feeding line 130 would at the contacting instant be reacted with each other to form calcium fluoride (CaF₂) crystals 146 in solid form on the crystallizing webs 144. The newly formed calcium fluoride crystals 146 serve as supports and play a roll of seed crystal cores, which would catalyst the successive chemical reaction to create calcium fluoride attached on the crystallizing webs 144 and the calcium fluoride crystals 146. In other words, the crystallizing webs 144 and the calcium fluoride crystals 146 at the time are served as the major chemical reaction area between the fluorine ions and calcium ions. This is why the crystallizing device 122 is able to effectively remove the most of fluorine ions in the fluoride-containing waste water regardless of whether the water quality of the fluoride-containing waste water in the tank body 120 is stable or not, which is helpful to maintain the water quality of the fluoride-containing waste water output to the reaction tank of fluoride-containing waste water 106 stable and keep the concentration of the fluorine ions therein low. As a consequence, the embodiment is able to reduce the calcium compound and the dosages of the coagulant and the coagulant aid in the successive process and largely lighten the dirt-depositing problem on the tank walls and in the pipelines of the system of treating waste water 100.

Note that the crystallizing device 122 includes a mechanism for removing the calcium fluoride crystals 146 on the crystallizing webs 144. In an embodiment, a programmable logic controller (PLC) (not shown) is used to electrically connect the third control valve 138 and the shaking part 140. To remove the calcium fluoride crystals 146 on the crystallizing webs 144, the PLC starts up the shaking part 140 so as to make the shaking part 140 reciprocate for swaying the crystallizing webs 144 on the supporting part 142; thus, the calcium fluoride crystals 146 on the crystallizing webs 144 would be dropped off to the bottom of the tank body 120 due to the gravity effect and the swaying action of the shaking part 140. Whenever the system of treating waste water 100 is on standby, the PLC starts up the third control valve 138 to remove the calcium fluoride crystals 146 on the bottom of the tank body 120. The crystallizing device 122 certainly can have a moving device (not shown) to move out the multiple crystallizing webs 144 from the crystallizing tank of fluoride-containing waste water 104. After the multiple crystallizing webs 144 is moved out of the crystallizing tank of fluoride-containing waste water 104 by the moving device and placed in another collecting tank (not shown), the shaking part 140 is used again to make the calcium fluoride crystals 146 on the crystallizing webs 144 dropped off to the collecting tank, following by collecting the dropped calcium fluoride crystals.

Continuing to FIG. 1 again, the reaction tank of fluoride-containing waste water 106 connects the crystallizing tank of fluoride-containing waste water 104 and the reaction tank of fluoride-containing waste water 108 and has a first agent-pouring pipeline 148. The reaction tank of fluoride-containing waste water 108 connects the coagulating tank 110 and has a second agent-pouring pipeline 150. The coagulating tank 110 connects the flocculating tank 112 and has a third agent-pouring pipeline 152 and a fourth agent-pouring pipeline 154. The flocculating tank 112 connects the sludge-precipitating tank 114 and has a fifth agent-pouring pipeline 156. The sludge-precipitating tank 114 connects the sludge-concentrating tank 115, and the sludge-concentrating tank 115 connects the machine for making sludge cake 116.

After the pre-treating of the crystallizing tank of fluoride-containing waste water 104, the fluoride-containing waste water sequentially flows through the reaction tanks of fluoride-containing waste water 106 and 108. In an embodiment, the calcium compound would be poured into the reaction tanks of fluoride-containing waste water 106 and 108 respectively through the first agent-pouring pipeline 148 and the second agent-pouring pipeline 150 and would react with the fluorine ions in the fluoride-containing waste water to create calcium fluoride (CaF₂) solids.

The fluoride-containing waste water induced into the coagulating tank 110 would conduct coagulating reaction with the coagulant added through the third agent-pouring pipeline 152 and 10% hydrochloric acid (HCL) or 10% sodium hydroxide (NaOH) added through the fourth agent-pouring pipeline 154 to form calcium fluoride flocs, wherein the coagulant is, for example, 10% aluminium salt or iron salt. The pH of the fluoride-containing waste water is kept at pH 6-8 by adding hydrochloric acid or the sodium hydroxide so as to enhance the coagulating effect.

The fluoride-containing waste water in the flocculating tank 112 would react with the coagulant aid poured from the fifth agent-pouring pipeline 156 to make the calcium fluoride flocs grown to facilitate further depositing. In an embodiment, the coagulant aid is, for example, macromolecule polymer with a percent of weight, for example, 33%. The sludge-precipitating tank 114 is for settling the calcium fluoride sludge. The sludge-concentrating tank 115 is for lowering the water content of the calcium fluoride sludge and shrinking the sludge. In an embodiment, the sludge-concentrating tank 115 is a gravity concentrating tank. The calcium fluoride sludge after dewatering is delivered to the machine for making sludge cake 116, where sludge cakes are made to make transporting and processing the sludge in the successive procedure more convenient.

Since the system of treating waste water 100 of the present invention employs the crystallizing tank of fluoride-containing waste water 104 and the crystallizing webs 144 in the crystallizing tank of fluoride-containing waste water 104, the dirt-depositing of the system of treating waste water 100 is improved. Besides, the fluoride-containing waste water after being treated by the crystallizing tank of fluoride-containing waste water 104 has a lower concentration of fluorine ions and a lower concentration of suspended solids, therefore, the dosages of the calcium compound, the coagulant and the coagulant aid are reduced along with a less yield of the sludge, which result in a less cost for treating the fluoride-containing waste water and a lighter burden for treating the sludge waste.

The method for treating fluoride-containing waste water would be depicted hereinafter based on an example of the system of treating waste water 100.

Continuing to FIGS. 1 and 2 again, first, the used fluoride-containing waste water would be poured into the tank of raw fluoride-containing waste water 102 through the first pipeline 118. Then, the fluoride-containing waste water and the calcium compound would be induced into the crystallizing tank of fluoride-containing waste water 104 respectively through the inlet pipeline of fluoride-containing waste water 126 and the agent-feeding line 130, so as to make the fluoride-containing waste water and the calcium compound reacted with each other to form calcium fluoride crystals (CaF₂) 146. The calcium compound is, for example, calcium hydroxide (Ca(OH)₂) or calcium chloride (CaCl₂), wherein the calcium fluoride crystals 146 are attached on the crystallizing web 144 in the crystallizing tank of fluoride-containing waste water 104. The crystallizing web 144 is disposed on the supporting part 142 in the crystallizing tank of fluoride-containing waste water 104. In an embodiment, the crystallizing tank of fluoride-containing waste water 104 disposes not only a crystallizing web 144, instead, disposes multiple crystallizing webs 144 on the supporting part 142. If more than one crystallizing web 144 are disposed, the crystallizing webs 144 can be arranged in parallel to each other, and the surfaces of the crystallizing webs 144 are perpendicular to or parallel to the bottom of the tank body 120. The material of the crystallizing web 144 is, for example, stainless steel 316 or nickel chromium molybdenum steel.

Note that the crystallizing web 144 can hold up the calcium fluoride crystals (CaF₂) 146 and makes them attached on the crystallizing web 144. The initially formed calcium fluoride crystals (CaF₂) 146 function like supports to attract incoming calcium fluoride crystals (CaF₂) 146 produced in the successive reactions, so that the incoming calcium fluoride crystals (CaF₂) 146 dwell on the crystallizing web 144 and the existed calcium fluoride crystals (CaF₂) 146. Along with a time history and the growing of the calcium fluoride crystals (CaF₂) 146, the fluorine ions (F⁻) would be effectively removed. Since most of the calcium fluoride crystals (CaF₂) 146 are built up on the crystallizing web 144, thus, the dirt-depositing on the various reaction tank bodies and the pipeline thereof in the system of treating waste water 100 can be improved, which is further helpful to lengthen the lifetime years of the system of treating waste water 100. In addition, the major chemical reactions to remove the fluorine ions (F⁻) occur on the crystallizing web 144. In fact, the crystallizing web 144 and the calcium fluoride crystals (CaF₂) 146 thereon are contributed to increase the chance of creating the calcium fluoride crystals (CaF₂) 146 by reacting between the fluorine ions (F⁻) and the calcium compound. As a result, the dosages of the calcium compound in the reaction tanks of fluoride-containing waste water 106 and 108 are largely lowered.

While the fluoride-containing waste water and the calcium are pouring, the fluoride-containing waste water and the calcium compound are stirred and mixed up by the agitator 124, which enhances the collision chance between the fluorine ions (F⁻) (not on the crystallizing web 144 and still free from reacting with the calcium compound) and the calcium compound, so as to reduce the concentration of the fluorine ions (F⁻) in the crystallizing tank of fluoride-containing waste water 104 as much as possible.

The method for treating fluoride-containing waste water of the present invention also includes removing the calcium fluoride crystals (CaF₂) 146 on the crystallizing web 144. In an embodiment, a programmable logic controller (PLC) (not shown) is used and electrically connected to the shaking part 140 and the third control valve 138. Whenever to clean up the calcium fluoride crystals (CaF₂) 146 on the crystallizing web 144, the PLC starts up the shaking part 140 to vibrate the crystallizing web 144; meanwhile, the calcium fluoride crystals (CaF₂) 146 would be dropped off from the crystallizing web 144 and fall to the bottom of the tank body 120 by means of gravity effect and the regular shake of the crystallizing web 144. When the system of treating waste water 100 is on standby, the PLC turns on the third control valve 138 at the bottom of the tank body 120, so as to move the calcium fluoride crystals (CaF₂) out of the tank body 120 via the crystals-outputting pipeline 132.

After that referring to FIG. 1, the fluoride-containing waste water in the crystallizing tank of fluoride-containing waste water 104 is drained out for the successive treating step. In an embodiment, the successive treating step is, for example, pouring calcium compound respectively through the first agent-pouring pipeline 148 of the reaction tank of fluoride-containing waste water 106 and the second agent-pouring pipeline 150 of the reaction tank of fluoride-containing waste water 108 so that the waste water flowing through the reaction tanks of fluoride-containing waste water 106 and 108 is able to react with the poured calcium compound to create calcium fluoride (CaF₂) solids. Further, a coagulating step is conducted in the coagulating tank 110, where the coagulant and 10% hydrochloric acid (HCL) or 10% sodium hydroxide (NaOH) are added respectively via the third agent-pouring pipeline 152 and the fourth agent-pouring pipeline 154 to create calcium fluoride flocs in the fluoride-containing waste water. The coagulant is, for example, 10% aluminium salt or 10% iron salt. Furthermore, coagulant aid is added via the fifth agent-pouring pipeline 156, so that the calcium fluoride flocs in the flocculating tank 112 can be further coagulated into larger flocs. The coagulant aid is, for example, macromolecule polymer. The calcium fluoride sludge is settled in the sludge-precipitating tank 114 and then is conveyed to the sludge-concentrating tank 115 for dewatering. The dewatered sludge is conveyed to the machine for making sludge cake 116 to make sludge cakes.

In summary, the present invention has at least following advantages:

1. Most of calcium fluoride crystals are grown on the crystallizing web, thus, the present invention is able to improve the dirt-depositing of the reaction tank body and the pipelines and further lengthen the lifetime years of the equipment of treating fluoride-containing waste water.

2. The crystallizing web is able to enhance the chance of creating the calcium fluoride, which contributes to largely reduce the dosage of the calcium compound in the reaction tank of waste water.

3. When the fluoride-containing waste water flows through the crystallizing web, the concentration of the suspended solids in the water is reduced, this is helpful to lower the usage amounts of the coagulant and the coagulant aid required by the successive chemical coagulating process.

4. The present invention produces less sludge than the prior art.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for treating fluoride-containing waste water, comprising:
inducing fluoride-containing waste water and calcium compound into a crystallization reaction tank having a plurality of crystallizing webs so as to conduct a reaction between the fluoride-containing waste water and the calcium compound and to form calcium fluoride (CaF₂) crystals on the crystallizing webs;
stirring the fluoride-containing waste water and the calcium compound; and
discharging the fluoride-containing waste water from the crystallization reaction tank to conduct a treating step.

2. The method for treating fluoride-containing waste water according to claim 1, wherein the material of the crystallizing webs comprises stainless steel 316 or nickel chromium molybdenum steel.

3. The method for treating fluoride-containing waste water according to claim 1, wherein the crystallizing webs in the crystallization reaction tank are arranged in parallel to each other.

4. The method for treating fluoride-containing waste water according to claim 1, wherein the surfaces of the crystallizing webs are perpendicular to or parallel to the bottom of the crystallization reaction tank.

5. The method for treating fluoride-containing waste water according to claim 1, wherein the calcium compound comprises calcium hydroxide (Ca(OH)₂) or calcium chloride (CaCl₂).

6. The method for treating fluoride-containing waste water according to claim 1, wherein the treating step comprises:
inducing the fluoride-containing waste water and the calcium compound into a reaction tank so as to make the calcium compound react with the fluoride-containing waste water to form calcium fluoride (CaF₂);
inducing the fluoride-containing waste water and coagulant into a coagulating tank so as to coagulate the calcium fluoride in the fluoride-containing waste water;
inducing fluoride-containing waste water and coagulant aid into a flocculating tank, and stirring the fluoride-containing waste water so as to form calcium fluoride flocs in the fluoride-containing waste water; and
inducing the fluoride-containing waste water into a sludge-concentrating tank.

7. The method for treating fluoride-containing waste water according to claim 6, wherein the coagulant comprises aluminium salt or iron salt.

8. The method for treating fluoride-containing waste water according to claim 6, wherein the coagulant aid comprises macromolecule polymer.

9. The method for treating fluoride-containing waste water according to claim 1, further comprising removing the calcium fluoride crystals on the crystallizing webs by shaking the crystallizing webs so as to make the calcium fluoride crystals dropped off from the crystallizing webs.

10. A crystallizing tank of waste water for a system of treating waste water, comprising:
a tank body;
a crystallizing device, disposed in the tank body, comprising:
a shaking part;
a supporting part, connecting the shaking part; and
a plurality of crystallizing webs, disposed on the supporting part;
an agitator, disposed in the tank body;
an inlet pipeline of waste water, connected between the tank body and a tank of raw waste water of the system of treating waste water;
an outlet pipeline of waste water, connected between the tank body and a reaction tank of waste water of the system of treating waste water; and
an agent-feeding line, disposed on the tank body.

11. The crystallizing tank of waste water according to claim 10, wherein the material of the crystallizing webs comprises stainless steel 316 or nickel chromium molybdenum steel.

12. The crystallizing tank of waste water according to claim 10, wherein the crystallizing webs in the crystallization reaction tank are arranged in parallel to each other.

13. The crystallizing tank of waste water according to claim 10, wherein the surfaces of the crystallizing webs are perpendicular to or parallel to the bottom of the crystallization reaction tank.

14. The crystallizing tank of waste water according to claim 10, wherein the agitator comprises propeller type agitator, paddle type agitator or turbine type agitator.

15. A system of treating waste water, comprising:
a tank of raw waste water;
a crystallizing tank of waste water, connecting the tank of raw waste water and comprising:
a tank body;
a shaking part, disposed in the tank body;
a supporting part, connecting the shaking part;
a plurality of crystallizing webs, disposed on the supporting part;
an agitator, disposed in the tank body; and
an agent-feeding line;
a reaction tank of waste water, connecting the crystallizing tank of waste water;
a coagulating tank, connecting the reaction tank of waste water;
a flocculating tank, connecting the coagulating tank; and
a sludge-concentrating tank, connecting the flocculating tank.

16. The system of treating waste water according to claim 15, wherein the material of the crystallizing webs comprises stainless steel 316 or nickel chromium molybdenum steel.

17. The system of treating waste water according to claim 15, wherein the crystallizing webs in the crystallization reaction tank are arranged in parallel to each other.

18. The system of treating waste water according to claim 15, wherein the surfaces of the crystallizing webs are perpendicular to or parallel to the bottom of the crystallization reaction tank.

19. The system of treating waste water according to claim 15, wherein the coagulating tank further comprises a first pipeline for pouring coagulant into the coagulating tank.

20. The system of treating waste water according to claim 19, wherein the coagulant comprises aluminium salt or iron salt.

21. The system of treating waste water according to claim 15, wherein the flocculating tank further comprises a second pipeline for pouring coagulant aid into the flocculating tank.

22. The system of treating waste water according to claim 21, wherein the coagulant aid comprises macromolecule polymer.
